(19) United States
(12) Patent Application Publication
(10) Pub. No.: US 2012/0265854 A1
(43) Pub. Date: Oct. 18, 2012

(54) NETWORK BASED LABORATORY FOR DATA ANALYSIS

(75) Inventors: Mikael Andersson-Olivecrona, Bjarred (SE); Peter Andersson, Malmo (SE)

(73) Assignee: FACTLAB, Malmo (SE)

(21) Appl. No.: 13/503,630

(22) PCT Filed: Oct. 22, 2010
(86) PCT No.: PCT/IB2010/002841

§ 371 Date: Jul. 2, 2012

Related U.S. Application Data
(60) Provisional application No. 61/254,489, filed on Oct. 23, 2009.

(51) Int. Cl. G06F 15/16

(52) U.S. Cl. 709/218

(57) ABSTRACT

A network based laboratory for data analysis is presented. The laboratory permits a user to submit an inquiry specifying the analysis to be performed, the sources of the data to be analyzed and the output format for the analysis results.

### BACKGROUND OF THE INVENTION

This application claims the benefit of priority to U.S. Provisional Application Ser. No. 61/254,489, filed Oct. 23, 2009 which is incorporated herein by reference in its entirety. All references that may be cited in this specification, and their references, are incorporated by reference herein where appropriate for teachings of additional or alternative details, features, and/or technical background.

### FIELD OF THE INVENTION

The present invention generally relates to a network based laboratory for performing comparative data analysis.

### SUMMARY OF THE INVENTION

In embodiments there is presented a network based data laboratory configured as one or more servers on the INTERNET. The data laboratory comprises the tools required to perform comparative analysis of data from diverse data bases operated and maintained by various organizations and entities around the world and a user friendly graphical user interface (GUI) that facilitates structuring an inquiry necessary to perform a comparative analysis of data obtained from the diverse data bases and presenting the results of the analysis in graphical or tabular formats as specified by the user. The data laboratory maintains traceability of each of the data elements to its originating source.

In embodiments there is presented a computer system comprising: one or more interconnected servers comprising a graphical user interface subsystem, the servers connected to a communications network and operatively configured to: accept a data analysis inquiry from a user; determine and communicate with one or more remote sources of data pertinent to the data analysis inquiry; receive the pertinent data from the remote sources; convert the pertinent data to a predetermined format; perform analysis defined by the data analysis inquiry on the converted pertinent data; present results of the analysis by means of the graphical user interface subsystem.

There is further presented, in embodiments, a method of performing data analysis comprising: accepting a data analysis inquiry from a user; determining and communicating with one or more remote sources of data pertinent to the data analysis inquiry; receiving the pertinent data from the remote sources; converting the pertinent data to a predetermined format; performing analysis defined by the data analysis inquiry on the converted pertinent data; presenting results of the analysis by means of the graphical user interface subsystem.

### BRIEF DESCRIPTION OF DRAWINGS

The accompanying figures incorporated in and forming a part of the specification illustrate several aspects of embodiments of the invention and, together with the description, serve to explain the embodiments.

FIG. 1 is a block diagram of an embodiment of a network based laboratory for data analysis.

FIG. 2 presents an embodiment of a web page that provides for user selection of language to be employed and the type of data analysis to be conducted.

FIG. 3 presents an embodiment of a web page that provides for user selection of sources of information to be included in the analysis.

FIG. 4 presents an embodiment of a web page that provides for user selection of geographical region-centric versus subject theme-centric.

FIG. 5 presents an embodiment of a web page that provides for user selection of subject theme.

FIG. 6 presents an embodiment of a web page that provides for user selection of specific aspects of the chosen subject theme.

FIG. 7 presents an embodiment of a web page that provides for user selection of countries or regions to be considered in the analysis.

FIG. 8 presents an embodiment of a web page that allows access to additional information on the selected counties.

FIG. 9 presents an embodiment of a web page that allows access to information on a country by country basis.

FIG. 10 presents an embodiment of a web page that allows selection of the output format.

FIG. 11 presents an embodiment of a web page illustrating data presented in a “bar chart ” format.

FIG. 12 presents an embodiment of a web page wherein additional countries may be included in the analysis.

FIG. 13 presents an embodiment of a web page that presents additional pertinent data.

### DETAILED DESCRIPTION OF THE INVENTION

In embodiments there is presented a system for parametrically analyzing data and facts retrieved from a diverse plurality of information sources for the purpose of identifying relationships between the retrieved data sets. The parametric analysis of the retrieved data and facts may be controlled by the user in near real time thus providing an interactive “laboratory” for studying relationships. The information sources may be accessed by means of communication networks such as the INTERNET, or by other media such as, for example, CDs or DVDs, data stored in electronic memories, printed publication converted to electronic format, data generated by extraction from near real-time sources such as video or still cameras, keyboards, speech recognition systems, etc. Traceability of the source of each fact is maintained throughout the analysis and output presentation process.

The system comprises an input/output graphical user interface (GUI) subsystem, a data acquisition subsystem, and a data processing subsystem. This specification comprises the GUI and the conversion of data formats into a common “standard” format which permits relational analysis. This conversion of data formats is also referred to as “production of variables.”

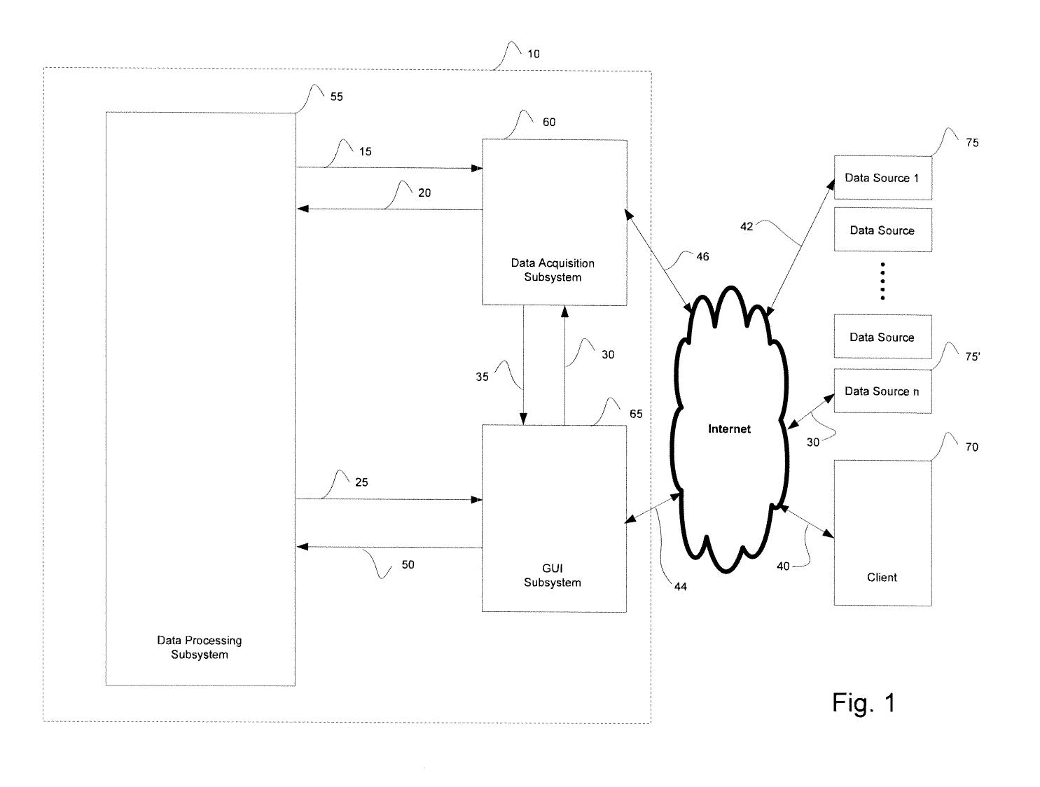

In an embodiment of the data laboratory, shown in FIG. 1, one or more servers 10 may comprise a data processing subsystem 55, a data acquisition subsystem 60 and graphical user interface subsystem (GUI) 65, for communicating, converting, and presenting data sought after by the user. A user interfaces with the data laboratory via a client 70, which could be any form of portal unto which the user may gain access to the INTERNET. Examples of portals may be a server, desktop computer, laptop, mobile telephone, electronic book reader (such as the iphone or ipad), voice only interfaces may also be used with voice to text or voice to data to build the necessary query, sought by the user. Other devices providing users having vision or hearing impairments can also be used to gain access to the INTERNET and the data retrieval system.

An embodiment of client 70 accesses the data retrieval servers over communication channels 40, 44 via the INTERNET to interface with the GUI subsystem 65 which respond to a users request seeking data. The GUI subsystem, builds a questionnaire to form a query hierarchy. The question posed by the system and responded to by the user are formed from predetermined knowledge. Some or all of the data formation constraints can be formed from knowledge gained from data previously ascertained from one or more data sources 75 or other external sources. Data sources may be INTERNET websites, data center repositories, free or paid databases, portable electronic or optical media or other known or yet formed sources of data.

The GUI subsystem 65, is connected via a bidirectional communication pathway 30, 35 with data acquisition 60 and also a bidirectional communication pathway 25, 50 with data processing subsystem 55. The data acquisition subsystem 65 is also connected via a bidirectional communication pathway 15, 20 with the data processing subsystem 60 and a bidirectional communication pathway 46, and 42 via the INTERNET 80 with data sources 75. Communications from the GUI subsystem 65 travel back to the user via the same communication channels 40, 44. The communication pathways represented herein may be formed by hardwire connections such a via Ethernet, or via wireless measures such as 802.11 standards or broadband via a communication service provider. Alternative communication pathway configurations are also envisioned such as having different pathways for incoming and outgoing data, such as the client sending request via broadband and receiving results via a wired connection pathway.

The GUI permits the user to input a query defining the topic area and the variables to be studied. The configuration of the GUI permits the user to provide the necessary topics and ranges of parameters by means of a hierarchal sequence of question screens which are configured, in an embodiment, to accept multiple choice responses. Other input modes such as keyboard entered text, computer mouse responses, voice recognition and video inputs may also be accommodated. The GUI is designed for remote INTERNET access to the data laboratory system.

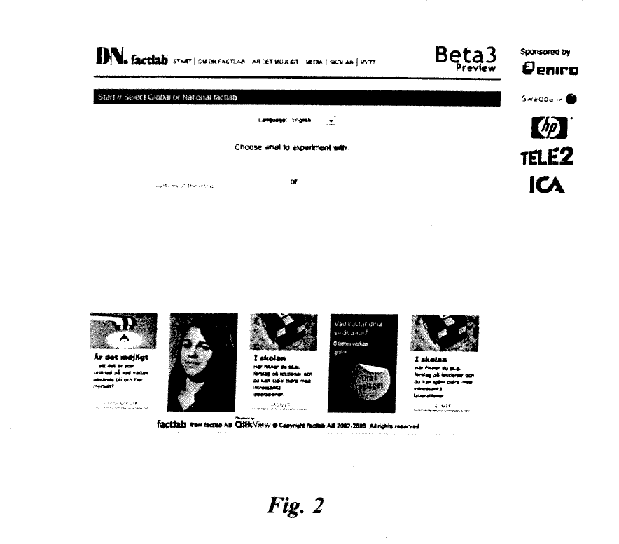

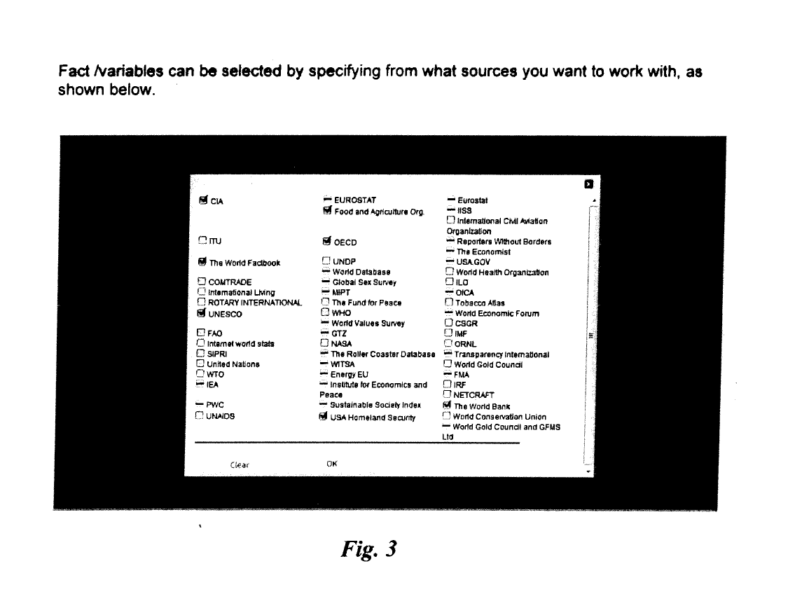

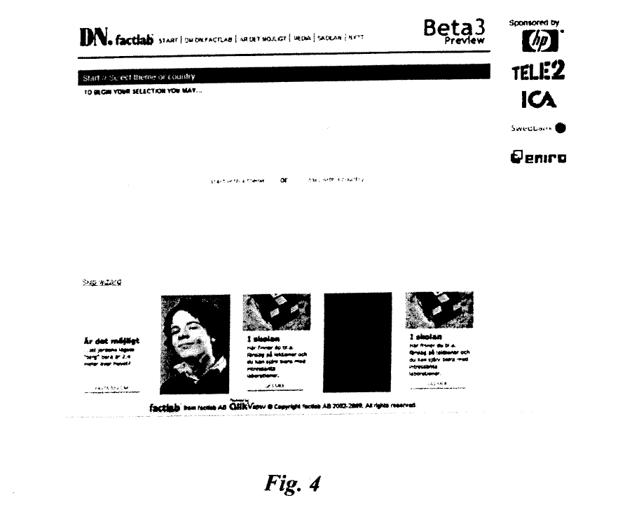

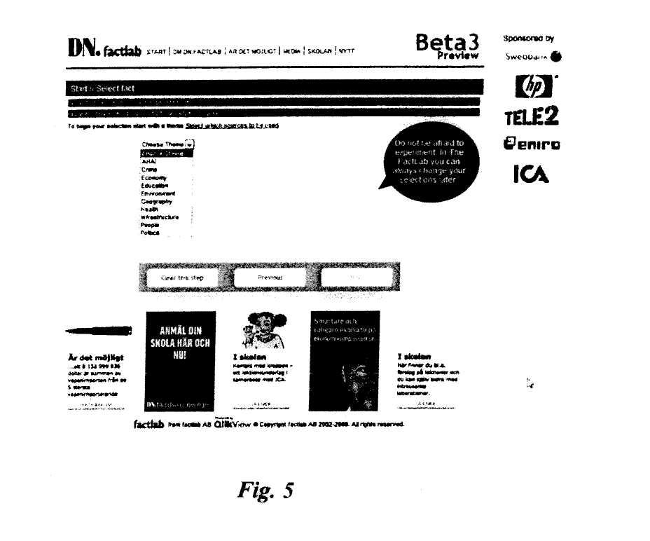

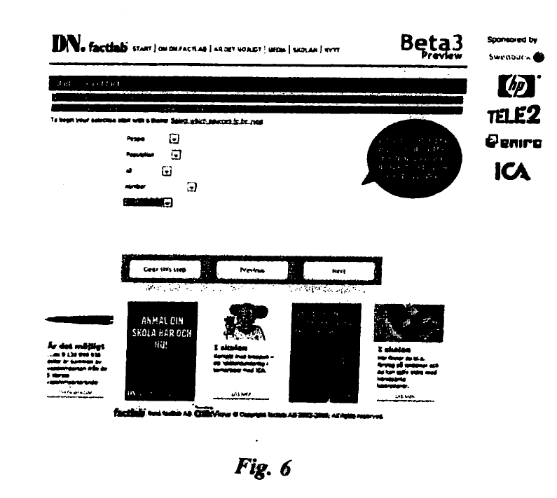

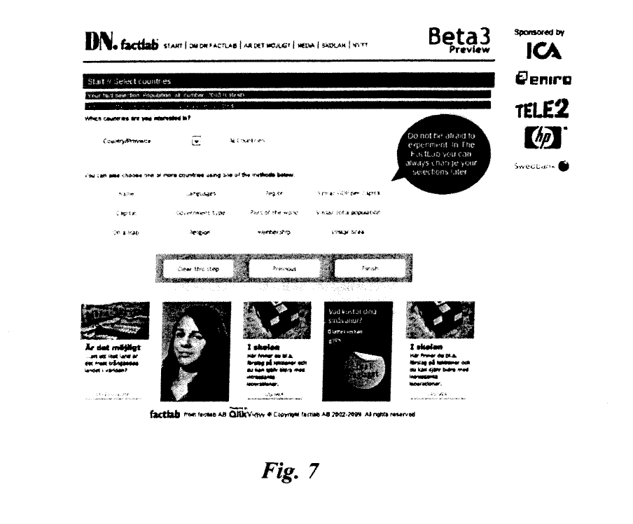

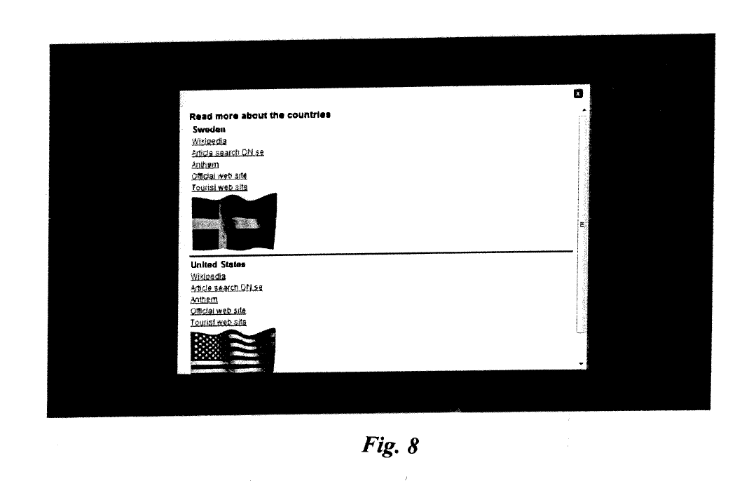

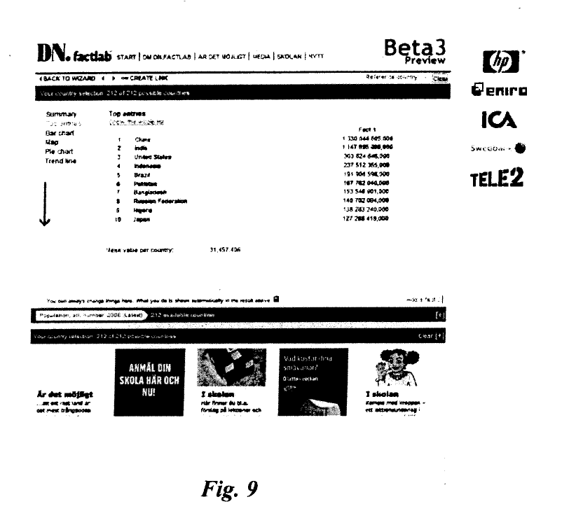

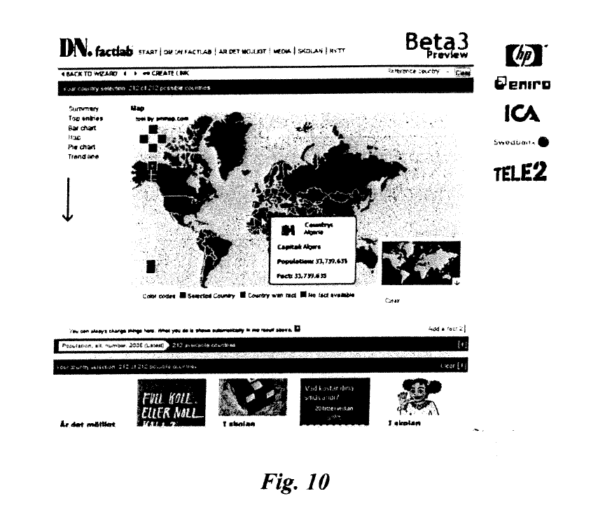

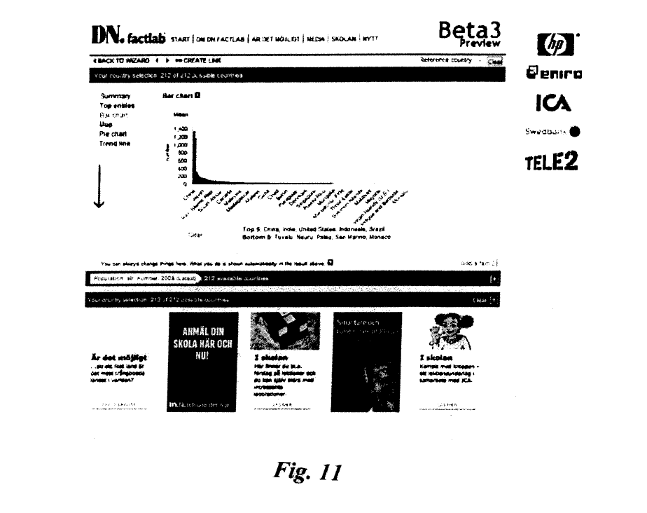

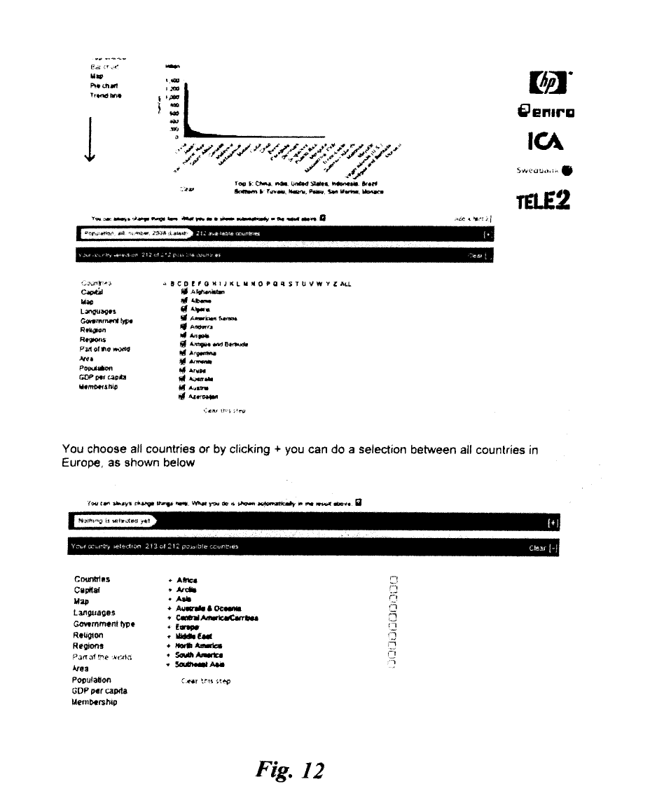

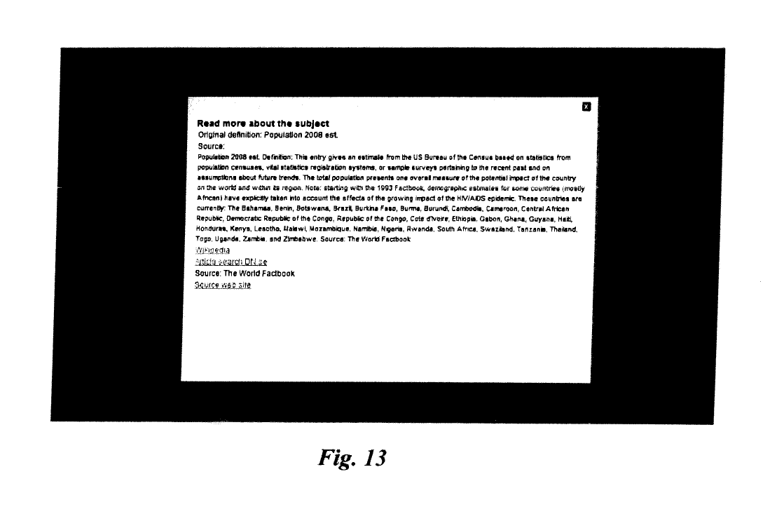

An embodiment of the GUI is presented by FIGS. 2 through 13. FIG. 2 is a design for a graphics display screen that provides for user selection of the language to be employed and the type of data analysis to be addressed in the session. FIG. 3 allows the user to select the sources of information to be included in the analysis. FIG. 4 is a design for a graphics display screen that provides for user selection as to whether the study will be geographical region-centric or subject theme-centric. Assuming that subject theme is selected, FIG. 5 is a design for a graphics display screen that provides for user selections of subject theme. FIG. 6 is a design for a graphics display screen that provides for user selection(s) of the subject theme to be studied. If, alternatively, geographical region-centric had been chosen, FIG. 7 would appear, which is a design for a graphics display screen that provides for user selections of countries or regions to be considered in the analysis. FIG. 8 provides links to INTERNET web pages where the user can obtain information on a country by country basis. FIG. 9 next appears which allows the user to access information on a country by country basis. FIG. 10 illustrates the presentation of output data in a “Map” format while FIG. 11 illustrates the presentation of output data in a “bar chart” format. FIG. 12. is a design for a graphics display screen that allows the user to add additional countries to the initially specified set. FIG. 13 is a design for a graphics display screen that presents additional pertinent data related to the analysis.

Having received the query parameters from the user input, the data processing system retrieves the necessary data and facts and transforms data and facts into the common format to be used. The production of the variables may comprise five steps:

1. Find the relevant variable value.

Relevant variable value can be either on the INTERNET, CD/DVD or in print(paper). The material available on the INTERNET is usually available only as a PDF file, Excel file or other proprietary format. A prerequisite requirement for handling a variable value is that it is collected and reported in accordance with the minimum statistical segment of the data laboratory. In this case, there must be a value for each of the countries of the world, and there must be values specified for the majority of the countries. To produce a variable to the data laboratory where the number of countries with variable value is set below 40% is seldom interesting.

2. Enter the variable value in the current regime.

The variable value specified in the database file should be in the order of the countries of the world.

3. “ASCII wash” of variable values

The obtained variable value must be filtered to remove any special characters by a method referred to as “ASCII-washing.” The collected variable value is stored and then retrieved from the Notepad program. Notepad does not handle special characters and therefore strips them from the variable.

4. Define and specify variable names

In the database file, the name of the variable is shown on line 1. This name appears in the data laboratory when searching for a variable to work with. The name should be descriptive not be not too long.

5. Enter the definition and any footnotes.

On the second line of the database is the variable collectors official name of the variable. This may differ from the name entered on line 1, especially if it is too long or otherwise unsuitable as a variable name. The name is followed by the definition of the variable. This definition should be the same as that provided by the original collector of the data. The definition is followed by the source reference and may also be supplemented by a clickable web address of the original collector. Finally, any footnotes provided by the original collector may be added. FIG. 10 is an illustrative example of a variable.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

What is claimed is:

1. A computer system comprising:
one or more interconnected servers comprising a graphical user interface subsystem, said servers connected to a communications network and operatively configured to:
accept a data analysis inquiry from a user;
determine and communicate with one or more remote sources of data pertinent to said data analysis inquiry;
receive said pertinent data from said remote sources;
convert said pertinent data to a predetermined format;
perform analysis defined by said data analysis inquiry on said converted pertinent data;
present results of said analysis by means of said graphical user interface subsystem.

2. A computer system, in accordance with claim 1, wherein said communications network is the INTERNET.

3. A computer system, in accordance with claim 1, wherein said data analysis inquiry comprises the type of analysis to be performed.

4. A computer system, in accordance with claim 1, wherein said data analysis inquiry comprises identification of said one or more remote sources of data.

5. A computer system, in accordance with claim 1, wherein said data analysis inquiry comprises the output format.

6. A computer system, in accordance with claim 1, wherein the traceability of said pertinent data is maintained through said data analysis and said presentation of said results operations.

7. A method of performing data analysis comprising:
accepting a data analysis inquiry from a user;
determining and communicating with one or more remote sources of data pertinent to said data analysis inquiry;
receiving said pertinent data from said remote sources;
converting said pertinent data to a predetermined format;
performing analysis defined by said data analysis inquiry on said converted pertinent data;
presenting results of said analysis by means of said graphical user interface subsystem.

8. A method, in accordance with claim 7, wherein said communicating is via the INTERNET.

9. A method, in accordance with claim 7, wherein said data analysis inquiry comprises the type of analysis to be performed.

10. A method, in accordance with claim 7, wherein said data analysis inquiry comprises identification of said one or more remote sources of data.

11. A method, in accordance with claim 7, wherein said data analysis inquiry comprises the output format.

12. A method, in accordance with claim 7, wherein the traceability of said pertinent data is maintained through said data analysis and said presentation of said results operations.
